(19) United States
(12) Patent Application Publication
(10) Pub. No.: US 2004/0154472 A1
(43) Pub. Date: Aug. 12, 2004

(54) Food steamer with scale

(75) Inventors: William J. Podl, Wayne, IL (US); Mark W. Podl, West Chicago, IL (US); William A. Snyder, Elgin, IL (US); Rudolph E. Knohl, Bartlett, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Doran Scales, Inc.

(21) Appl. No.: 10/359,883

(22) Filed: Feb. 6, 2003

(51) Int. Cl. A23L 1/00

(52) U.S. Cl. 99/341

(57) ABSTRACT

Quality and portion concerns in providing food products are minimized in an apparatus that includes a steamer (10) with an upwardly opening steam head (16). A load cell (42) is mounted to a cabinet (12) of the steamer (10) and includes a post (52) mounting a baffle (68) which in turn surrounds the steamer head (16). A product platter/food support (70) is placed on the baffle (68) so that the latter directs steam to food material on the product platter/food support (70) as it is being weighed. Consequently, the desired hot temperature of the food may be maintained while an accurately sized portion, by weight, is provided.

### FIELD OF THE INVENTION

This invention relates to apparatus for performing two functions simultaneously, specifically, steaming a product such as a food product while an accurate portion of the product is assembled. The invention also relates to a method of making a sandwich-like food product.

### BACKGROUND OF THE INVENTION

Among the concerns of the food industry, two are of considerable importance. The first is, of course, quality of the product. The second is providing an accurate portion of the product. Poor quality, of course, is an obvious problem. Where quality is poor, sales are lost and as a result, market share will decline because of a lack of repeat business.

Accurate portioning is likewise of concern. If the portion actually given is less than that stated, or if it is perceived to be less than that expected, customer dissatisfaction results and in many cases labeling laws may be violated. To avoid this, many businesses, to assure that each portion is of the minimum desired size, provide portions that on the average are slightly larger than the minimum to assure that all portions will be of the minimum size. The difference between the accurate portion size and what is actually received by the customer is termed “give away” and over millions of portions, can be of considerable economic impact.

While these problems plague the food industry generally, they also permeate the fast food business where competition is intense and quality of the product is an overriding factor.

In many fast food operations, the food product that is to be dispensed includes multipiece food products as, for example, slices of meat. In some operations, the sliced meat portions are preproportioned into individual servings. However, preproportioning food into individual portions is expensive and consequently, undesirable in high volume operations.

Thus, in most high volume operations where meat slices, for example, are being served in a sandwich or the like, a loaf of the meat product is cooked and then placed in a slicer. Slices coming off of the slicer, as needed, are proportioned by estimating and/or by weighing, and then placed in a food product such as a sandwich. The difficulty here is that all too frequently, food quality may be lowered. Specifically, there may be a time lapse between the cutting the hot cooked meat loaf and its ultimate loading as an accurate portion into the sandwich. Consequently, it has been proposed to introduce a heating step into the food preparation process between the slicing of the cooked meat loaf and the assembly of the sandwich.

While this improves product quality, it represents an additional capital investment for the equipment needed to heat the sliced meat and introduces more time into the processing of a given sandwich by introducing an additional manipulative step requiring human intervention, thus making the entire process more labor intensive and thus expensive.

The present invention is directed to overcoming one or more of the above difficulties.

### SUMMARY OF THE INVENTION

It is the principal object of the invention to provide a new and improved apparatus for processing multipiece material by warming such as steaming while accurately proportioning the same into predetermined portions. It is also a principal object of the invention to provide a new and improved method for assembling a sandwich-like food product.

An exemplary embodiment of the invention achieves the foregoing in a food steamer and scale for weighing a food product as it is being steamed and includes a steamer, including a cabinet having an upwardly open, heated steamer head into which aqueous material is introduced to be vaporized therein. A load cell is mounted on the cabinet in spaced relation to the steamer head and includes an upwardly directed post formed of a material of poor thermal conductivity. An indicator is connected to the load cell for providing a visual indication of the weight of a food product being weighed as it is steamed and a baffle is removably mounted on the post and includes a vertically extending skirt extending about the periphery of the steamer head. The baffle has a lower opening into which steam may pass from the steamer head and an upper opening through which the steam may exit the baffle. A food support is removably disposed on the baffle over the upper opening and has a foraminous section aligned with the upper opening through which steam may pass to steam food on the food support along with a framing section supporting the foraminous section.

In one embodiment, the skirt substantially surrounds the steamer head without contacting the cabinet to form a barrier to access to the steamer head when the baffle is mounted on the post.

A preferred embodiment contemplates that the steamer head have a cylindrical exterior and that the baffle be a circular ring of larger diameter than the steamer head.

In one embodiment, the lower edge of the skirt, at a location opposite the post, is in sufficiently close proximity to an upper wall of the cabinet so as to engage the wall in interfering relation before a damaging force can be applied to the load cell as a result of downward forces applied to the baffle when mounted on the post.

In one embodiment, the post, below its upper end, includes a seat and the baffle includes a yoke fitted about the post and resting on the seat.

In a preferred embodiment, the post, at a location above the seat and oppositely of the steamer head, includes a vertical surface extending to the seat and abutting the yoke to locate the baffle so that the skirt extends about the periphery of the steamer head. The post, above the seat and oppositely of the vertical surface, has a relief confronting the yoke so that the baffle may freely move upwardly or upwardly and rotatably relative to the seat to prevent damaging forces from being applied to the load cell by way of the post when the baffle is moved upwardly or upwardly and rotatably relative to the seat.

In preferred embodiment, the framing section of the food support is generally planar and the foraminous section is recessed downward from the framing section into the baffle.

Preferably, the recessed foraminous section is of the same shape and just slightly smaller than the upper opening of the baffle to provide a centering function for centering the food support on the baffle. Even more preferably, the foraminous section has a periphery shaped as a shallow, inverted frustocone and upper opening is circular and of a diameter equal to or just greater than the major base of the frustocone.

Preferably, the framing section defines an insulating handle.

In one embodiment, the foraminous section is formed of screen.

In a preferred embodiment, the post is located to one side of the steamer head. Even more preferably, the load cell and the post are both located to one side of the steamer head.

According to another facet of the invention, a method of preparing a warmed, accurately portioned, sandwich-like food product is provided and includes the steps of (a) providing a foraminous product platter, (b) placing an estimated portion of a multipiece food material on the product platter and directing steam through the foraminous product platter to warm the estimated portion to a desired temperature while adding or removing pieces of the food product, as needed, until an accurate portion of the food product is present on the food platter, (c) placing a first sandwich forming piece of food on the accurate portion while on the product platter, (d) supporting the first sandwich forming piece against the accurate portion while inverting the product platter with the accurate portion and the first sandwich forming piece thereon, (e) removing the product platter from the accurate portion and the first sandwich forming piece, and (f) placing a second sandwich forming piece on the accurate portion oppositely of the first sandwich forming piece.

Other objects and advantages will become apparent from the following specification taken in connection with the accompanying drawings.

### DESCRIPTION OF THE DRAWINGS

FIG. 1 is a perspective, exploded view of a steamer and scale apparatus made according to the invention;

FIG. 2 is a side elevation of the exemplary embodiment;

FIG. 3 is a plan view of one type of a food support/product platter utilized in the invention;

FIG. 4 is a side elevation of the food support/product platter of FIG. 3; and

FIG. 5 is a perspective view of a modified embodiment of a food support/product platter.

### DESCRIPTION OF THE PREFERRED EMBODIMENT

An exemplary embodiment of a steamer and scale made according to the invention will be described herein in the environment of and as being useful in the steaming and weighing of individual portions of a food product. However, it will be understood that the invention may be used with efficacy in non-food applications where steaming and weighing may be required. Hence, no limitation to use with food is intended except insofar as expressly stated in the appended claims.

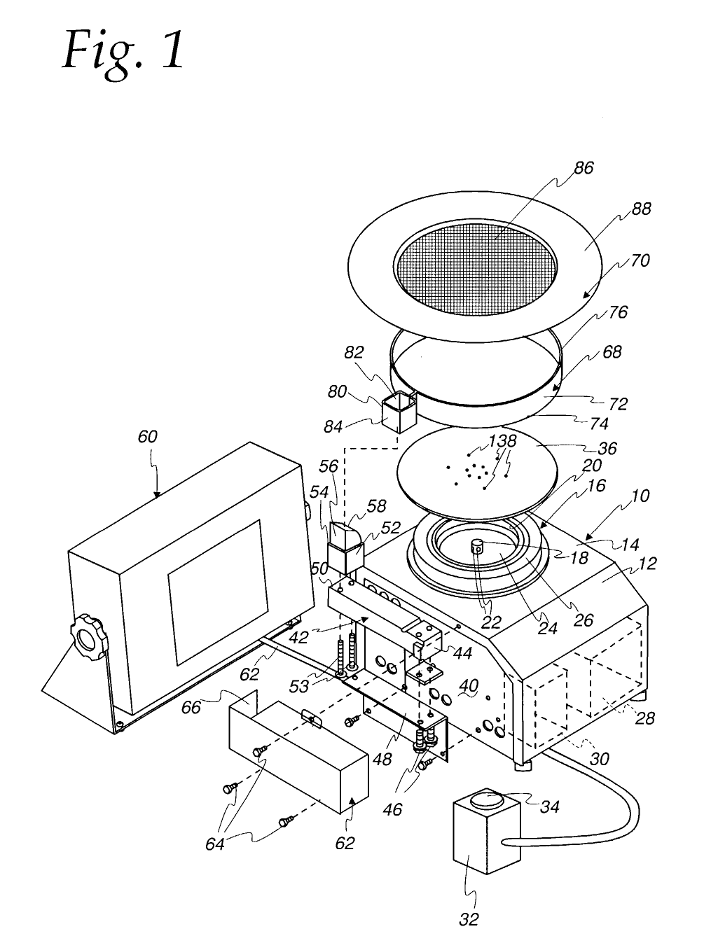

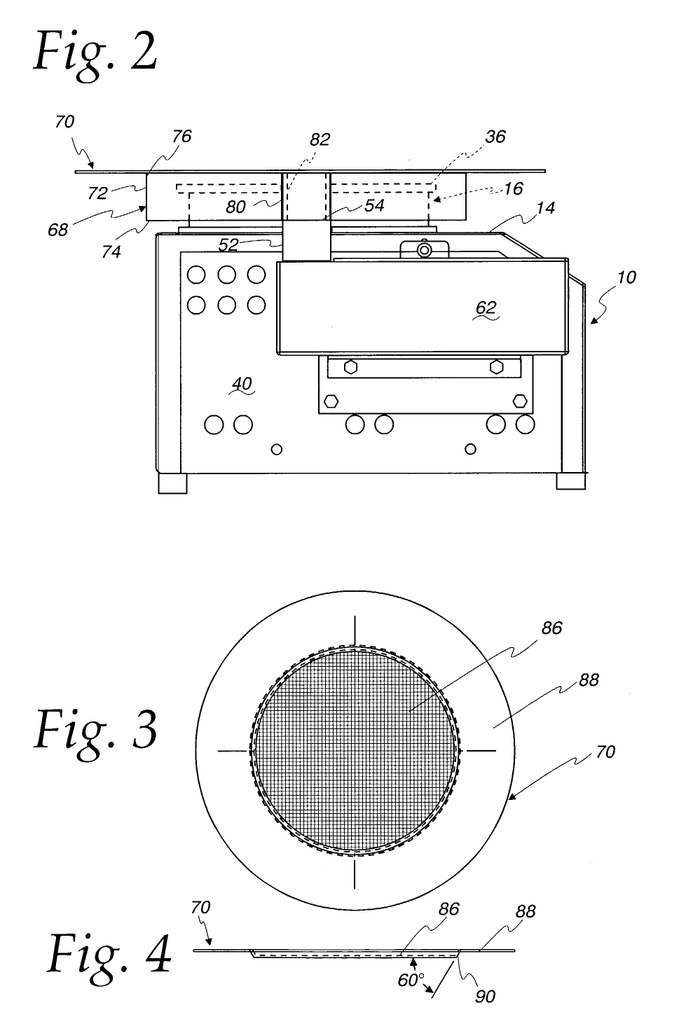

With the foregoing in mind, and with reference to the drawings, and FIGS. 1 and 2 in particular, an apparatus for simultaneously steaming and weighing food will be described. A steaming apparatus, generally designated 10, includes a cabinet 12 having an upper surface 14. An upwardly opening, hollow cylindrical steaming head, generally designated 16, extends slightly upwardly from the upper surface 14 and includes a central post 18 located within a central recess 20 of the head 16. The post 18 includes a plurality of small nozzles or apertures 22 through which an aqueous material, normally water, may be injected into the recess 20. The bottom 24 and side wall 26 of the steam head 16 are typically heated as by an internal electrical resistance heating unit to a temperature sufficient to rapidly vaporize the aqueous material when it is injected through the apertures 22.

Within the cabinet 10 is reservoir 28 for the aqueous material to be injected together with a pump 30 for pumping the aqueous material from the reservoir 28 to the steamer head 16. A remote start switch 32 having a manually operable push button 34 is provided and in the usual case, controls will be provided so that upon pushing push button 34, the pump 30 will be energized for a preset time period to deliver a predetermined charge of aqueous material to the steamer head 16.

A diffuser plate 36 covers the steamer head 16 and in the usual case will be secured as by a threaded fastener (not shown) to a bore (not shown) in the top of the post 18. The diffuser plate 36 is a thin, circular plate of slightly greater diameter that the steamer head 16 and includes a series of small ports 38 arranged in the star-like configuration shown in FIG. 1 and through which the vapor may exit the recess 20 in a upward direction. The diffuser 36 acts to distribute the vapor generated within the steamer head 16 in a predetermined pattern as well as to prevent unvaporized droplets of the aqueous material from exiting the recess 20.

In some cases, reservoir 28 and the pump 30 may be located exteriorly of the cabinet 14. The steamer 10 also includes a removable side panel 40 which may be used in a kit form of the invention as will become apparent hereinafter.

It should be noted that the particular construction of the steamer forms no part of the invention except insofar as the same includes an upwardly opening steam head 16. The steamer described is in fact, conventional and may be, for example, a model no. 6QS1.5 “mini-steamer” available from Cleveland Range, Inc. of Cleveland, Ohio.

A second component of the system is a load cell, generally designated 42 of the type known as a “single point load cell”. It is a cantilever load cell which, in the exemplary embodiment, is mounted at one end 44 via threaded fasteners 46 and a spacer to an L-bracket 48 which in turn is mounted by threaded fasteners to the removable side panel 40. The load cell 42 may be conventional and is commercially available as a Model No. 1022 cantilever load cell from Doran Scales, Inc., 1315 Paramount Parkway, Batavia, Ill. 60510. The load cell 42 is elongated horizontally as illustrated and at its free end 50 opposite the end 44 at which it is secured to the bracket 48 mounts an upwardly extending post 52. The post 52 is secured to the end 50 by threaded fasteners 53 and preferably is made of an insulating material, i.e., a material of poor thermal conductivity. In the embodiment illustrated, the post 52 is square in horizontal cross section and intermediate its ends includes a peripheral shoulder 54. By reason of the mounting of the load cell 42 to the side panel 40 of the cabinet 10, the load cell 42 and the post 52 will be to one side of the steamer head 16. The side of the post 52 opposite the steamer head 16 is designated 56 and is a vertical flat surface. The surface of the post 52 facing the steamer head 16 and above the shoulder 54 is designated 58 and is preferably diagonal although the same may be curved as illustrated in FIG. 1. The surface 58 is a relief surface and whether curved or diagonal, is such that no point on it, when measured to the intersection of the vertical surface 56 and the shoulder 54 is greater than the dimension between the vertical surface 56 where it merges into the shoulder 54 and that part of the shoulder directly opposite therefrom, that is, the part of the shoulder nearest the steamer head 16.

A conventional weight indicator, generally designated 60, is connected by an electrical cord 62 to the load cell 42 in a conventional way. One example of such an indicator that is commercially available is Model No. 7000 XLM available from Doran Scales, Inc. whose address has been previously stated herein.

A protective cover, generally designated 62, is secured by threaded fasteners 64 to the cabinet 10 to house the load cell to protect the same from damage. The cover 62 includes an upper opening 66 at one end thereof through which the post 52 freely extends, that is, extends upwardly from the load cell 42 without contacting the cover 62.

The assembly is completed by a baffle, generally designated 68, and a product platter/food support, generally designated 70, which will now be described. It is to be particularly noted that while the description describes a baffle 68 and the product platter/food support 70 as individual, separable items, the two could be fabricated as a unitary, one piece structure if desired. Separate components are, however, preferred to allow easier manipulation of the product that is to be steamed and weighed while resting on the food support/product platter 70 and to allow easier cleaning of both components where sanitary conditions are required.

As seen in FIG. 1, the baffle 68 is a circular ring having a vertical side wall or skirt 72. The lower edge 74 of the skirt 72 defines a lower opening while the upper edge 76 defines an upper opening. The diameter of the baffle 68 is just somewhat larger than the outer diameter of the steamer head 16 as can be ascertained in FIG. 2 so as to allow the baffle 68 to fit about the diffuser plate 36 and/or the steamer head 16. Specifically, the steamer head 16 enters the baffle 68 through the lower opening defined by the lower edge 74 such that the baffle 68 will confine vapor emanating from the apertures 38 (FIG. 1) in the diffuser plate 36 and confine the same for upwardly movement toward the upper opening defined by the upper edge 76.

One side of the baffle 68 is provided with a yoke 80 having a square opening 82 of a size to fit on the upper end of the post 52 and abut against the seat 54 as illustrated in FIG. 2. The interior side of one wall 84 of the yoke 80 is adapted to abut the vertical surface 56 of the post 52. Thus, the baffle 68 is removably mounted on the post 52.

The product platter/food support 70 includes a generally central foraminous section 86 surrounded by a planar, framing section 88 to which the foraminous section 86 is secured. In one embodiment, the foraminous section 86 is formed of screen or mesh, preferably of stainless steel, for sanitary purposes. However, it is to be understood that the product platter/food support 70 could be molded of a suitable, temperature resistant plastic or a perforated plate or the like.

Preferably, the framing section 70 is made of a material of poor thermal conductivity, i.e., an insulator, and extends well beyond the periphery of the vertical side wall 72 of the baffle 68 so as to be easily graspable by a user of the apparatus. By being made of an insulating material, the framing section 88 also serves as a handle by which the product platter/food support 70 may be grasped without fear of exposure of the hands of the operator to undesirably high temperatures.

In the embodiment illustrated and as mentioned earlier, the product platter/food support 70 is removably mounted on the baffle 68 and before further describing the product platter/food support 70, a number of features of the construction thus far described will be mentioned.

If a tipping force is applied upwardly to the baffle 68 (or the product platter/food support 70 when integral with the baffle 68), the same may move upwardly and/or upwardly and rotatably about a pivot axis that coincides with the upper surface of the seat 54 at its location remote from the steamer head 16. Because of the presence of the relief 58, such a force will not be applied to the post 52 to be transmitted to the load cell 42. Thus, the relief 58 provides a means of allowing inadvertent upward and/or upwardly and pivotal movement of the baffle 68 without application of a potentially damaging torsional force to the load cell 42.

At the same time, the proximity of the lower edge 74 of the baffle 68 allows the same to engage the upper surface 14 of the cabinet 10 if such a force is applied downwardly. Thus, the upper surface 14 of the cabinet, due to the proximity to the lower edge 74 of the baffle 68, serves as a stop to prevent a torsional force from being transmitted to the load cell 42 when a downward force is applied to the baffle 68 at a location spaced from the yoke 80. If desired, a small tab could be located on the baffle 68 to mount an adjustable screw to provide an adjustable stop surface as well.

As seen in FIG. 2, the proximity of the lower edge 74 of the baffle 68 virtually completely houses the steam head 16, thereby preventing access to it. During operation, steamer head 16 can become quite hot and by denying access to it in the manner just mentioned, the possibility of burns is substantially reduced.

Referring now to FIGS. 3 and 4, it will be seen that the foraminous section 86 is recessed or cupped downwardly from the framing section 88. This brings the product platter/food support on which food may be placed while steaming into closer proximity to diffuser 36 and the steam openings 38 therein. Preferably, the recess is formed by a peripheral wall 90 at the interface of the foraminous section 86 and the frame section 88 that is in the form of an inverted, shallow frustocone is illustrated in FIG. 4. The major base of the peripheral wall 90 is preferably the same size or just slightly smaller than the inside diameter of the ring forming the baffle 68. The peripheral wall 90 thus serves to center the product platter/food support 70 on the baffle 68.

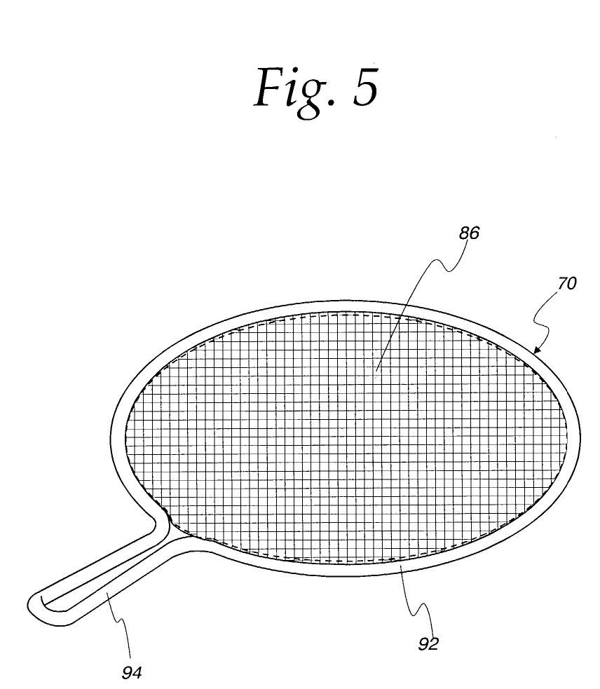

FIG. 5 illustrates an alternative embodiment of the product platter/food support 70. In this case, a planar, circular rod-like framing section 92 is provided with a protrusion 94 which serves as a handle for the product platter/food support 70. The rod-like material 92 may be formed of metal or plastic as desired. When formed of plastic, an insulating material is preferred, i.e., a material of poor thermal conductivity. When formed of metal, it is desirable that the handle or protrusion 94 be of sufficient length that it will not be appreciably heated by conduction or by the steam passing through the central foraminous section 86 secured to the framing section 92.

In use, for example in the making of a sandwich or the like, a multipiece food item such as meat slices is placed on the foraminous section 86 while the same is supported by the baffle 68 in the usual case. The amount placed on the foraminous 86 is an estimated portion, i.e., estimated to weigh approximately some predetermined amount, and can normally be determined easily by an operator of the device with relatively little experience. The push button 34 (FIG. 1) is operated by the operator to cause the steaming to begin. Simultaneously, an indication of the weight of the estimated portion on a foraminous section 86 will be seen on the indicator 70 and pieces of food may be added to or taken away from the mass on the foraminous section 86 to achieve an accurate portion by weight. All the while, the food is being warmed by steam.

When the accurate weight is achieved and the steaming cycle is ongoing or completed, one half of a piece of food used in making a sandwich as, for example, half of a bun, is placed on the food while the food is still resting on the foraminous section 86.

At this point, the product platter/food support 70 may be inverted along with the food material on the foraminous section 86 and the bun half by supporting the bun half against the food to hold the same against the foraminous section 86. Inversion will be approximately 180° and when that is accomplished, the product platter/food support 70 will now be uppermost and may be removed, allowing food to remain resting on the bun half, which will be lowermost. The other half of the bun may then be applied and the sandwich is complete. It may then be wrapped or placed on a serving plate as desired and served to the customer.

From the foregoing, it will be appreciated that the invention provides a number of advantages that overcome the problems with prior method and apparatus. Most importantly, it combines weighing and warming or cooking into a single operation to provide a time and space savings. It also provides a convenient means and method of forming a sandwich that allows partial formation of the sandwich while the food material being warmed and/or cooked is still on the product platter/food support 70, eliminating any need for removing the food to be placed on sandwich components such as a bun half or the like. Consequently, the amount of additional labor involved with the warming process is minimized.

The spacing of the lower edge 74 of the baffle 68 and/or the provision of the relief 58 on the post 52 substantially reduce the possibility of damage occurring to the load cell 42 as a result of rough handling. Consequently, the device is readily usable by relatively unskilled operators.

The use of a post 52 of relatively poor thermal conductivity provides thermal isolation between the baffle 68 and the product platter/food support 70 which are subject to heat and the load cell 42 to assure long life of the load cell 42 as well as weight determinations that are not influenced by temperature fluctuation.

The system allows simultaneous loading of the product platter/food support 70 and weighing of the material thereon to speed up the sandwich forming process and when the product platter/food support 70 and baffle 68 are separate constructions, cleaning of the same is readily achieved by reason of the simplicity of the construction of each. Further, the downwardly recessing of the foraminous section 86 of the product platter/food support 70 allows the product to be heated to be brought in closer proximity to the steamer head 16 to minimize the possibility of undesirable diffusion of the steam. The provision of a gripping portion in the form of either the protrusion 94 in the embodiment shown in FIG. 5 or the insulated framing section 88 in the embodiment shown in FIGS. 3 and 4 allows the food to be readily handled while still on the product platter/food support 70 to eliminate any need for removing the food from the foraminous section 86 before fabrication of the ultimate product, such as a sandwich, is initiated. The recessed construction of the foraminous section 86 also is employed to provide a centering function for the product platter/food support 70 on the baffle 68 and while perforations in a plate may be employed, the use of a screen maximizes the free flow area of steam flowing from the steamer head 16 to the product to be steamed for uniformity. The size of the mesh forming the foraminous section 86 can be chosen to minimize sticking, depending upon the product that is being steamed and if desired, the foraminous section 86, whether of screen or whether of perforations, can be provided with an antimicrobial coating for sanitary purposes.

The unique construction of the baffle and its relation to other components of the system achieves three functions with but a single element, including confining the vapor so that substantially all of the vapor is applied to the material being warmed, providing interference with the top of the cabinet to protect the load cell and preventing the hot steamer head from being accessed by an operator.

The apparatus is constructed for ready use as a kit to retrofit existing steamers. Because the load cell is typically mounted to a removable side wall of the steamer cabinet, a kit including a new side wall with the load cell and cover already mounted thereon can be employed to replace the existing side wall of an existing steamer. All that then need be done is to connect the load cell to the indicator, mount the baffle on the post and place the food support/product platter on the baffle. Some or all of the indicator, baffle and food support/product platter can form the kit along with the new side wall having a load cell (with the post already mounted thereon) and suitable fasteners as required. Alternatively, a kit comprising the load cell, baffle, food support/product platter and suitable fasteners for securing the load cell to a steamer cabinet, with or without the indicator could be provided to steamer manufacturers for installation on their products as an OEM attachment. As still another alternative, the load cell could be mounted on a free standing pedestal in such a way that the baffle 68 overlies the steamer head.

Other advantages will readily occur to those skilled in the art.

1. A food steamer and scale for weighing a food product as it is being steamed, comprising:
a steamer, including a cabinet having an upwardly open, heated, steamer head into which aqueous material is introduced to be vaporized therein;
a load cell mounted on said cabinet in spaced relation to said steamer head and including an upwardly directed post thereon;
an indicator connected to said load cell for providing a visual indication of the weight of a food product being weighed as it is steamed;
a baffle removably mounted on said post and including a vertically extending skirt extending about the periphery of said steamer head, said baffle having a lower opening into which steam may pass from said steamer head, and an upper opening through which steam may exit the baffle; and
a food support disposed on said baffle at said upper opening, said food support having a foraminous section aligned with said upper opening through which steam may pass to steam food on said food support and a framing section supporting said foraminous section.

2. The food steamer and scale of claim 1 wherein said skirt substantially surrounds said steamer head without contacting said cabinet to form a barrier to access to said steamer head when said baffle is mounted on said post.

3. The food steamer and scale of claim 2 wherein said steamer head has a cylindrical exterior and said baffle is a circular ring of larger diameter than said steamer head.

4. The food steamer and scale of claim 1 wherein a lower edge of said skirt opposite said post is in sufficiently close proximity to an upper wall of said cabinet so as to engage the wall in interfering relation before damaging force can be applied to the load cell as a result of downward forces applied to said baffle when mounted on said post.

5. The food steamer and scale of claim 1 wherein said post, below its upper end includes a seat and said baffle includes a yoke fitted about said post and resting on said seat.

6. The food steamer and scale of claim 5 wherein said post, above said seat and oppositely of said steamer head includes a vertical surface extending to said seat and abutting said yoke to locate said baffle so that said skirt extends about the periphery of said steamer head, said post, above said seat and oppositely of said vertical surface, having a relief confronting said yoke so that said baffle may freely move upwardly or upwardly and rotatably relative to said seat to prevent damaging forces from being applied to said load cell by way of said post when said baffle is moved upwardly or upwardly and rotatably relative to said seat.

7. The food steamer and scale of claim 1 wherein said framing section is generally planar and said foraminous section is recessed downward from said framing section into said baffle.

8. The food steamer and scale of claim 7 wherein said recessed foraminous section is of the same shape and just slightly smaller than said upper opening to provide a centering function for centering said food support on said baffle.

9. The food steamer and scale of claim 1 wherein the foraminous section has a periphery shaped as a shallow inverted frustocone and said upper opening is circular and of a diameter equal to or just greater than the major base of said frustocone.

10. The food steamer and scale of claim 1 wherein said framing section defines an insulating handle.

11. The food steamer and scale of claim 1 wherein said foraminous section is formed of screen.

12. The food steamer and scale of claim 1 wherein said post is located to one side of said steamer head.

13. The food steamer and scale of claim 1 wherein a load cell and said post are located to one side of said steamer head.

14. The food steamer and scale of claim 1 wherein said post is formed of a material of poor thermal conductivity.

15. In combination,
a steamer including a cabinet having side walls and an upper wall and an upwardly opening, generally cylindrical steamer head extending upwardly from said upper wall;
a support post located to one side of said steamer head and having a seat near an upper extremity of the post;
a load cell mounted to said cabinet and having said post mounted thereon;
a ring-like baffle surrounding said steamer head in slightly spaced relation above said upper surface and extending above said steamer head to define a flow path for steam exiting said steamer head, act as a barrier to access to a cylindrical side of said steam head, and to cooperate with said upper surface to prevent application of damaging force to said load cell;
a yoke connected to one side of said baffle and extending to said upper extremity to be removably impaled thereon and seated on said seat;
a relief at the interface of said yoke and said upper extremity configured to allow said yoke to move relatively freely on said upper extremity in at least one direction to prevent damaging forces from being applied to said load cell; and
a product platter supported by said baffle and having an insulated handle and a recessed foraminous center nested in said ring-like baffle in close proximity to said steamer head.

16. A method of preparing a warmed, proportioned, sandwich-like food product, comprising:
(a) providing a foraminous product platter;
(b) placing an estimated portion of a multipiece food material on the product platter and directing steam through the foraminous product platter to warm the estimated portion to a desired temperature while adding or removing pieces of the food product, as needed, until an accurate portion of the food product is present on the food platter;
(c) placing a first sandwich forming piece of food on the accurate portion while on the product platter;
(d) supporting the first sandwich forming piece against the accurate portion while inverting the product platter, the accurate portion and the first sandwich forming piece;
(e) removing the product platter from the accurate portion on the first sandwich forming piece; and
(f) placing a second sandwich forming piece on the accurate portion oppositely of the first sandwich forming piece.

17. A food steamer and scale for weighing a food product as it is being steamed, comprising:
a steamer, including a cabinet having an upwardly open, heated, steamer head into which aqueous material is introduced to be vaporized therein;
a load cell mounted on said cabinet in spaced relation to said steamer head and including an upwardly directed post thereon;
an indicator connected to said load cell for providing a visual indication of the weight of a food product being weighed as it is steamed;
a baffle removably mounted on said post and including a vertically extending skirt extending about the periphery of said steamer head, said baffle having a lower opening into which steam may pass from said steamer head, and an upper opening through which steam may exit the baffle; and
a food support removably located on said baffle at said upper opening, said food support having a foraminous section aligned with said upper opening through which steam may pass to steam food on said food support.

18. The food steamer and scale of claim 17 wherein said food support includes a framing section supporting said foraminous section and is removably received on said baffle.

19. The food steamer and scale of claim 17 wherein said post and said load cell are located to one side of said steamer head and said post is formed of a material having poor thermal conductivity.

20. A kit for installation on a steamer or the like comprising:
a load cell adapted to provide weight indicative electrical signals to an indicator and having a mounting end and an opposite force receiving end;
a post on said force receiving end through which a force may be applied to the load cell force receiving end;
a baffle having an upper opening surrounded by a generally closed periphery defined by a depending skirt adapted to surround a steam head on a steamer and a mounting yoke on one side of the skirt removably received on said post; and
a foraminous food support located on said baffle oppositely of said depending skirt and over said upper opening.

21. The kit of claim 20 further including fasteners for fastening said load cell mounting end to a steamer.

22. The kit of claim 20 further including a removable steamer housing panel and fasteners mounting said load cell mounting end to said housing panel.

23. The kit of claim 20 further including an indicator connected to said load cell to receive said signals therefrom and provide a visual indication of the force represented thereby.

24. A food steamer and scale for heating and weighing a food product, comprising:
a steamer, including a cabinet having an upwardly open steamer head into which aqueous material is introduced to be vaporized therein;
a load cell on said cabinet;
a product platter having a foraminous section at least partially surrounded by a rim, said foraminous section being depressed with relation to said rim to extend downwardly toward said steamer head;
an indicator connected to said load cell for providing a visual indication of the weight of a food product on said product platter; and
a support structure for removably supporting said product platter with said foraminous section at, but in noncontacting relation with, said upwardly open steamer head to be aligned therewith so that vaporized aqueous material vaporized by said steamer head will be directed through said foraminous section to food on said product platter, said support structure being connected to said load cell free of said cabinet so that the food on said product platter will be weighed when said product platter is on said support structure.

25. The food steamer and scale of claim 24 wherein said cabinet includes a protective cover and said load cell is within said protective cover.

26. The food steamer and scale of claim 24 wherein said load cell is located to one side of said steamer head.

27. The food steamer and scale of claim 24 further including a baffle for confining vapor emanating from said steamer head to said product platter.

28. The food steamer and scale of claim 27 wherein said baffle is on said support structure.
